(19) United States
(12) Patent Application Publication
(10) Pub. No.: US 2006/0002705 A1
(43) Pub. Date: Jan. 5, 2006

(54) Decentralizing network management system tasks

(76) Inventors: Linda Cline, Forest Grove, OR (US); Christian Maciocco, Tigard, OR (US); Srihari Makineni, Portland, OR (US); Manav Mishra, Kirkland, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,612

(22) Filed: Jun. 30, 2004

(51) Int. Cl. H04B 10/08; H04B 17/00

(52) U.S. Cl. 398/33

(57) ABSTRACT

A system to decentralize network management tasks. The system includes an Optical Device Control (ODC) to provide management functionality of an optical network at a network element of the optical network. The ODC includes a control plane, a data plane, and an interface to pass information between the control plane and the data plane. The system also includes a Network Management System (NMS) communicatively coupled to the ODC and at least one optical device communicatively coupled to the ODC.

### BACKGROUND

1. Field

Embodiments of the invention relate to the field of networks and more specifically, but not exclusively, to decentralizing network management system tasks.

2. Background Information

Network management in optical networks has traditionally been implemented as a centralized control, with the control systems and optical network devices performing management processing as little as possible. As complexity in optical devices and networks increases, and the number of managed devices grows, it becomes an increasingly difficult management problem to centralize all functions.

One of the scalability problems with a large optical network is the volume of statistics and events that must be analyzed and processed by a centralized management system, such as a Network Management System (NMS). A single hardware failure can escalate into a large number of alarms that need to be handled with great efficiency to isolate the failure and select a solution or workaround. A link failure can cause these alarm notifications to be generated from all affected network elements. As the size of the network grows and the number of optical devices increases, this can swamp a centralized management system.

Further, centralized management systems encounter a high amount of latency to accommodate changes to the network configuration. Protocols, such as the Link Capacity Adjustment Scheme (LCAS), can be used to signal changes, but usually such changes must be pre-approved by the NMS. Such a scheme does not provide a mechanism to make configuration changes based on current network traffic conditions.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a block diagram illustrating one embodiment of a network environment that supports decentralizing NMS tasks in accordance with the teachings of the present invention.

FIG. 1B is a block diagram illustrating one embodiment of a network element in accordance with the teachings of the present invention.

FIG. 2 is a block diagram illustrating one embodiment of an architecture to decentralize NMS tasks in accordance with the teachings of the present invention.

FIG. 3 is a block diagram illustrating one embodiment of an architecture to decentralize NMS tasks in accordance with the teachings of the present invention.

FIG. 4 is a block diagram illustrating one embodiment of an architecture to decentralize NMS tasks in accordance with the teachings of the present invention.

FIG. 5 is a block diagram illustrating one embodiment of an architecture to decentralize NMS tasks in accordance with the teachings of the present invention.

FIG. 6A is a flowchart illustrating one embodiment of the logic and operations to decentralize NMS tasks in accordance with the teachings of the present invention.

FIG. 6B is a flowchart illustrating one embodiment of the logic and operations to decentralize NMS tasks in accordance with the teachings of the present invention.

FIG. 6C is a flowchart illustrating one embodiment of the logic and operations to decentralize NMS tasks in accordance with the teachings of the present invention.

FIG. 6D is a flowchart illustrating one embodiment of the logic and operations to decentralize NMS tasks in accordance with the teachings of the present invention.

FIG. 7 is a block diagram illustrating one embodiment of a line card to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

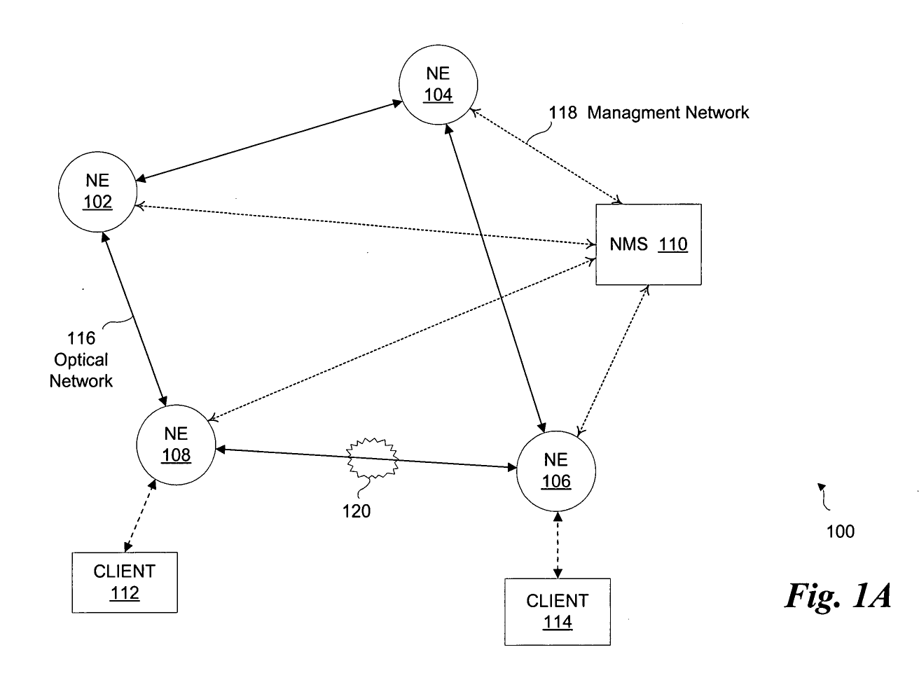

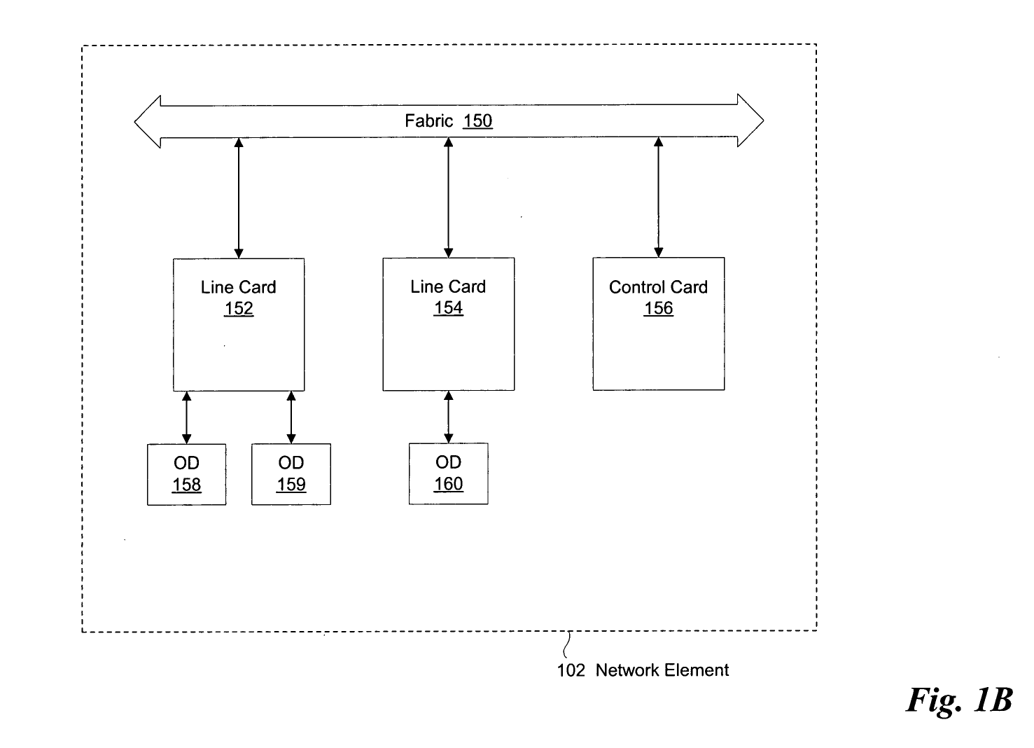

Referring to FIG. 1A, a network 100 according to one embodiment of the present invention is shown. Network element (NE) 102 is coupled to network element 104. Network element 104 is coupled to network element 106, which in turn is coupled to network element 108. Network element 108 is coupled to network element 102. Network elements 102, 104, 106, and 108 are coupled by optical connections, such as optical fiber. In one embodiment, communications between network elements is in accordance with the Synchronous Optical Network (SONET) interface standard. NE's 102-108 form an optical network 116. While the embodiment of FIG. 1A shows network elements 102, 104, 106, and 108 in a ring topology, it will be understood that other arrangements are within the scope of embodiments of the present invention.

Network 100 also includes a Network Management System (NMS) 110. NMS 110 provides management and controllability of the network elements 102-108. In one embodiment, NMS 110 is coupled to each NE 102-108 by an Ethernet connection and communications between NMS 110 and the network elements is in accordance with the Internet Protocol (IP). In another embodiment, management information may be imbedded in a SONET transmission between network elements and NMS 110.

In one embodiment, NMS and its connections to NE's 102-108 form a management network 118. In one embodiment, management network 118 includes a Data Communication Network (DCN). NMS 110 has a network wide view of optical network 116 and allows network managers to monitor and maintain optical network 116. In one embodiment, NMS 110 provides provisioning of network resources, receives alarm notification and correlation, and gathers statistics regarding network traffic and other data. In accordance with embodiments described herein, network elements 102-108 perform processing of various management tasks and report the results of such processing to NMS 110.

In general, provisioning involves allocating network resources to a particular user. For example, in FIG. 1A, a client 112 is coupled to NE 108 and a client 114 is coupled to NE 106. In one embodiment, clients 112 and 114 include IP routers used by a company. In this example, traffic between clients 112 and 114 are routed along the optical connection between NE's 106 and 108. In one embodiment, provisioning for clients 112 and 114 may be performed by network elements 106 and/or 108.

Alarm correlation involves pinpointing the event(s) that triggered one or more alarms in a network. In optical network 116, a single failure event may trigger multiple alarms at various places throughout the network. Multiple network elements may detect a failure and report the failure to NMS 110. For example, in FIG. 1A, a break 120 in the optical connection between NE 106 and NE 108 may cause multiple alarms throughout optical network 116. In one embodiment, network element 108 may analyze the alarms in order to discover where the failure has occurred and may report a single alarm to NMS 110. NE 108 may report the break 120 while suppressing numerous associated alarms.

Turning to FIG. 1B, an embodiment of network element 102 is illustrated. Network element 102 may include a line card 152, a line card 154, and a control card 156 coupled by a fabric 150. Fabric 150 is used to transfer control and data traffic between the cards. In one embodiment, fabric 150 includes a backplane. In another embodiment, fabric 150 includes an interconnect based on Asynchronous Transfer Mode (ATM), Ethernet, Common Switch Interface (CSIX), or the like.

Line card 152 is coupled to optical devices (OD's) 158 and 159, and line card 154 is coupled to optical device 160. Optical devices 158, 159 and 160 include optical framers, optical transponders, optical switches, optical routers, or the like. In one embodiment, optical devices include devices capable of processing SONET traffic.

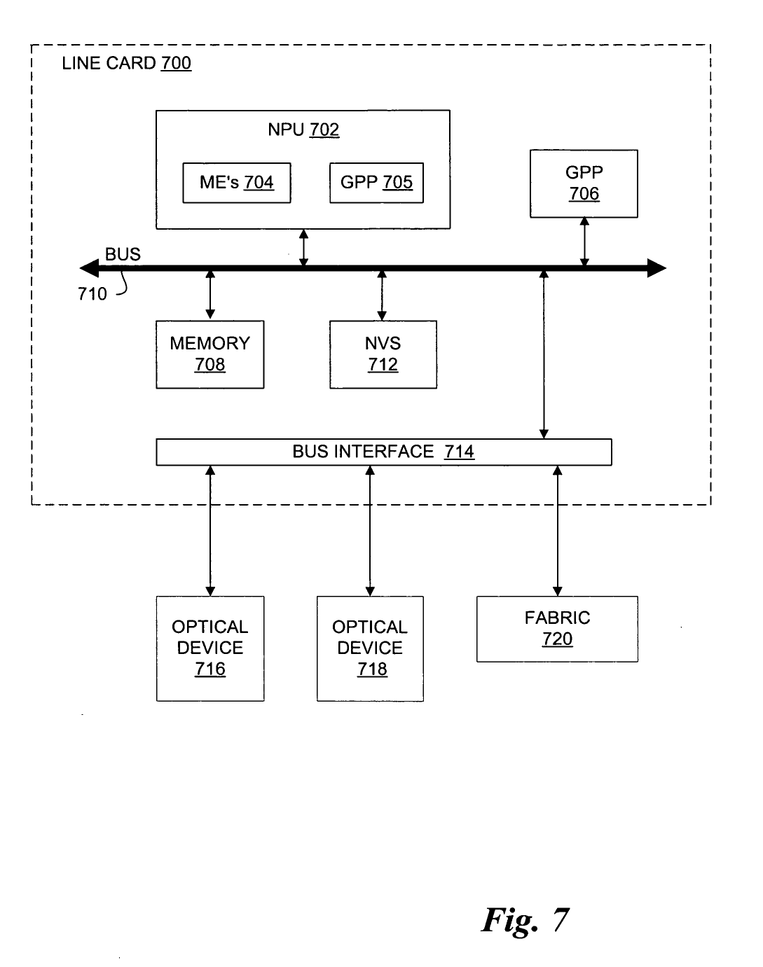

In one embodiment, each line card 152 and 154 includes one or more Intel® IXP network processors. In another embodiment, control card 156 includes an Intel Architecture (IA) processor. An embodiment of a line card is discussed below in conjunction with FIG. 7.

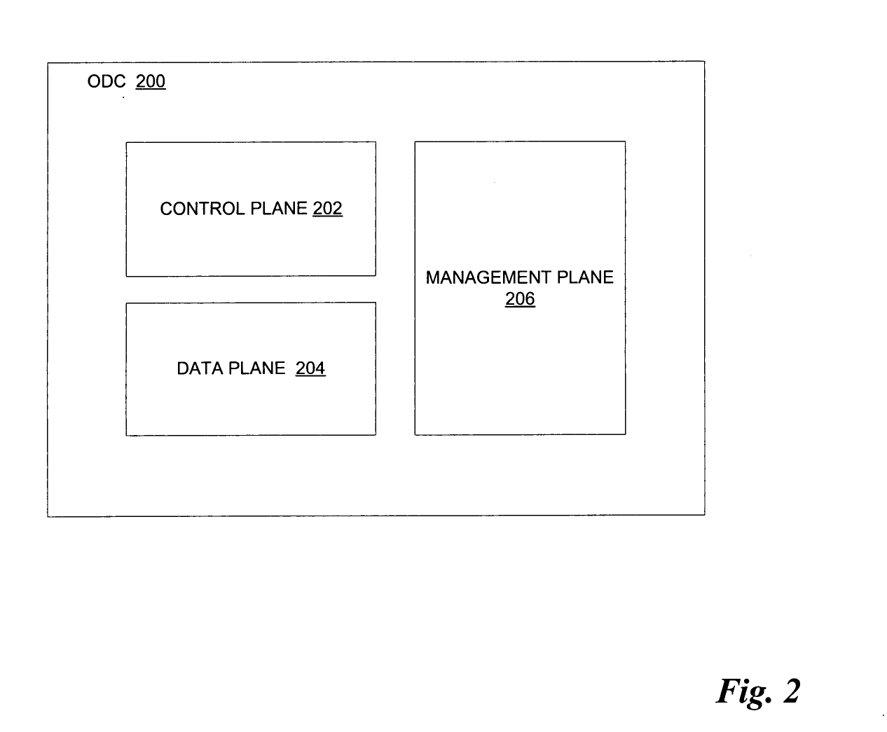

Referring to FIG. 2, an architecture model showing an embodiment of an Optical Device Control 200 is shown. ODC 200 provides management functionality for an optical network at the network element level. ODC 200 includes a control plane 202, a data plane 204, and a management plane 206. In one embodiment, ODC 200 is substantially compliant with the Intel® Internet Exchange Architecture (IXA).

Control plane 202 handles various tasks including routing protocols, providing management interfaces, such as Signaling Network Management Protocol (SNMP), and error handling and logging. Data plane 204 performs packet processing and classification. In one embodiment, Application Program Interfaces (API's) provide interfaces between control plane 202 and data plane 204. Some interfaces have been standardized by industry groups, such as the Network Processing Forum (NPF) (www.npforum.org) and the Internet Engineering Task Force (www.ieff.org). Some embodiments described herein may operate substantially in compliance with these interfaces.

Management plane 206 includes components that span data plane 204 and control plane 206 to provide network management functionality at the network element level. In one embodiment, these components take the form of API's operating in the control plane and the data plane (discussed further below).

Referring to FIG. 1B, in one embodiment, control card 156 performs control plane processing, while line cards 152 and 154 perform data plane processing. In another embodiment, portions of control plane processing may be distributed to and execute on line cards 152 and 154. It will be understood that the control and data planes do not have to physically reside on the same network element, but may be on separate systems connected over a network.

In one embodiment, instructions for the control plane and the data plane are loaded into memory devices of the control card and line card, respectively. In one embodiment, these instructions may be loaded using a Trivial File Transfer Protocol (TFTP) of a boot image over an Ethernet connection from a server. In another embodiment, the instructions may be transferred from NMS 110 over management network 118.

In one embodiment, network elements implement a fastpath-slowpath design. In this scheme, as packets enter a network element, various processes to handle the packets are divided between a fastpath or a slowpath through the network element. Fastpath processes include normal packet processing functions and usually occur in the data plane. Processes such as exceptions and cryptography are handled by the slowpath and usually occur in the control plane. In one embodiment, management processes as described herein are handled in the slowpath. Changes affected by ODC 200 may result in changes in fastpath processing of packets.

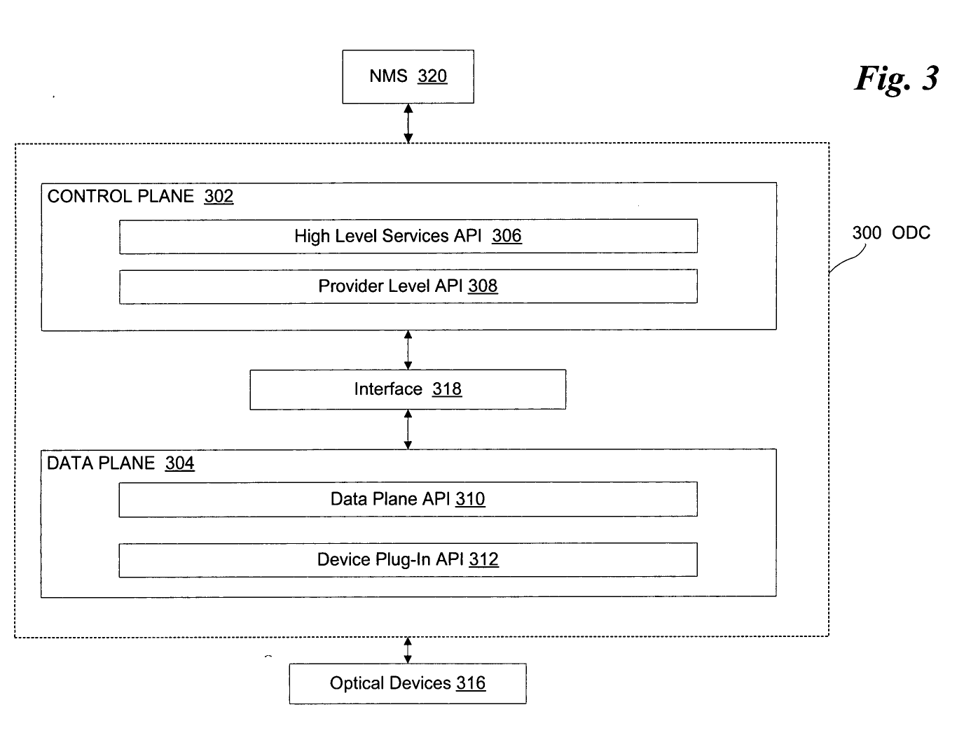

Turning to FIG. 3, an embodiment of an ODC 300 is shown. ODC 300 includes control plane 302 and data plane 304. An interface 318 is used to pass information between control plane 302 and data plane 304. Control plane 302 includes High Level Services API (HLAPI) 306 and Provider Level API 308. Data plane 304 includes Data Plane API 310 and Device Plug-in API 312. NMS 320 and optical devices 316 are communicatively coupled to ODC 300. FIGS. 3-5 illustrate embodiments of an ODC having a single control plane and a single data plane for the sake of clarity, however, it will be understood that the ODC may include one or more control planes, one or more data planes, or any combination thereof.

ODC 300 components span the control plane and data plane to provide management functionality at the network element level. The functionality of these components provide a high level interface with fine grained control to configure and manage optical devices. ODC 300 also provides support for interaction with optical device drivers. Example functions provided by ODC 300 include alarm correlation, event logging, filtering and propagation, statistics and diagnostic information collection, provisioning information management, and policy administration.

In one embodiment, NMS 320 communicates with ODC 300 using the High Level Services API 306. HLAPI 306 may be used by NMS 320 to receive control information, alarm notification, and statistics from ODC 300. HLAPI 306 may be supported on the control plane of the network element or may be supported by a proxy to the network element.

In one embodiment, Provider Level API 308 may handle notifications coming from the data plane 304. This will include fault notifications, such as alarms and events, as well as provide a configuration interface for requesting statistics and configuring statistic granularity and other attributes. Statistics may be periodically propagated via reports or retrieved via requests.

In another embodiment, Provider Level API 308 may provide a control plane side interface for control of optical devices 316. In this particular embodiment, API 308 may also provide a control plane side interface for other components of data plane 304 for downloading information to the data plane hardware for processing on data plane 304.

Data plane 304 includes Data Plane API 310 and Device Plug-in API 312. Data Plane API 310 may provide management functionality on the data plane side of ODC 300. API 310 propagates information to the control plane 302 using interface 318. In one embodiment, Data Plane API 310 executes on a general purpose processor of a network processor and is not part of fastpath packet processing.

Device Plug-in API 312 may provide a common interface for most optical devices as well as support the specific functionality that may be featured by a particular type of optical device. API 312 may provide a single point of control for all optical devices attached to the network element.

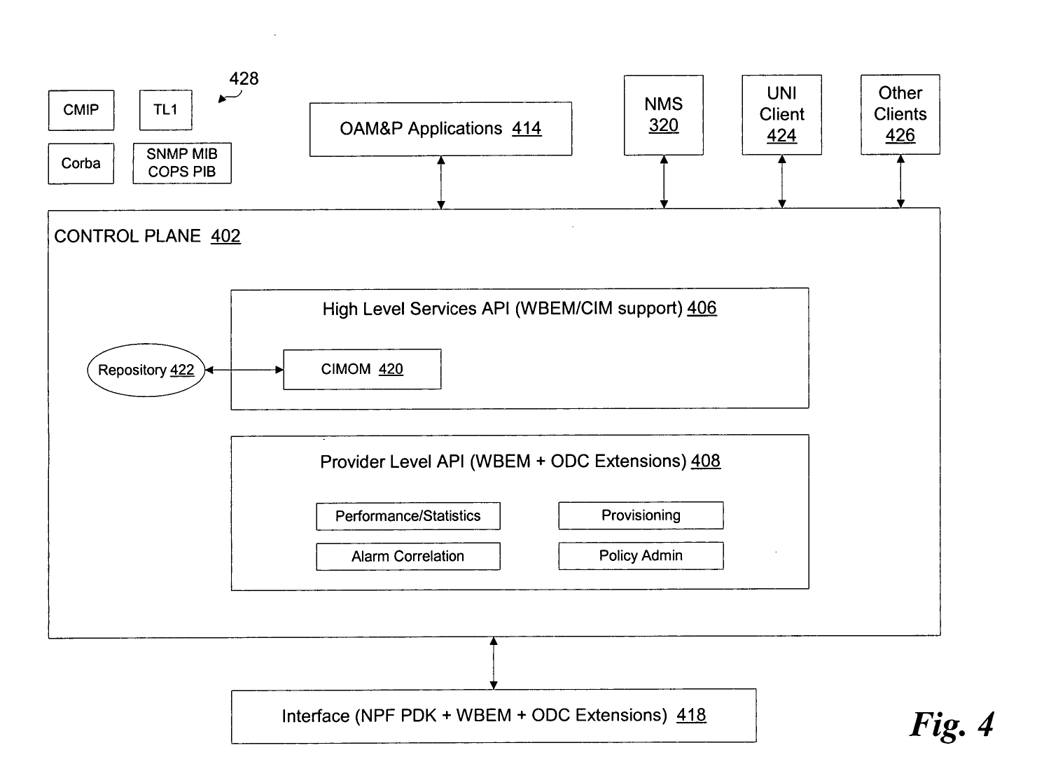

Turning to FIG. 4, an embodiment of a control plane 402 is illustrated. Control plane 402 includes High Level Services API (HLAPI) 406 and Provider Level API 408. In one embodiment, in order to provide compatibility with a variety of network management standards and protocols (e.g., Transaction Language 1 (TL1), Common Management Information Protocol (CMIP), and SNMP), HLAPI 406 supports a standard interface that supports extensible Markup Language (XML).

In one embodiment, this standard interface includes the Distributed Management Task Force (DMTF) Web Based Enterprise Management/Common Information Model (WBEM/CIM). DMTF is an industry organization concerning network environments (see www.dmff.org). WBEM/CIM supports adapters that may be used to integrate with other standards to maximize system flexibility; WBEM/CIM provides a common framework for management applications. WBEM provides a standardized, environmentally independent way to process management information across a variety of devices. CIM includes a set of modeled objects to define and describe numerous aspects of an enterprise environment from physical devices to network protocols. CIM also provides methods for extending the model to include additional devices and protocols. Some embodiments described herein may operate substantially in compliance with the WBEM/CIM.

In an embodiment of HLAPI 406 using WBEM/CIM, HLAPI 406 may include a CIM Object Manager (CIMOM) 420. CIMOM 420 receives data regarding optical devices and replies to requests for such data. CIMOM 420 may use a Repository 422 to maintain this data. Repository 422 stores configuration data and other information associated with optical devices communicatively coupled to the ODC. Such data includes statistical information, configuration information, and event/alarm notification mechanisms. In an embodiment, not using WBEM/CIM, Repository 422 may use a generic object base for maintaining data.

Similarly as discussed above in conjunction with FIG. 3, Provider Level API 408 handles notifications coming through interface 418 from the data plane and provides a control plane side interface to optical devices. API 408 supports statistical/performance data collection, fault notifications that may generate alarms, provisioning, and policy administration.

In one embodiment to support these management functions, API 408 may serve as a WBEM provider to CIMOM 420; API 408 provides data to CIMOM 420 that may be kept in Repository 422. API 408 may also be used to retrieve data from Repository 422 using CIMOM 420. In another embodiment, other entities in the control plane 402 may call the Provider Level API 408.

In another embodiment, API 408 may also support a direct functional API for in process calls, and a Remote Procedure Call (RPC) interface of API 408 for out of process calls. In this embodiment, API 408 provides an alternative to using HLAPI 406 that is text and HyperText Transfer Protocol (HTTP) based due to CIM/XML.

In one embodiment, Provider Level API 408 supports WBEM plus ODC extensions. ODC extensions include additions and/or modifications to the WBEM/CIM specifications to support ODC as described herein. In one embodiment, ODC extensions add to the standard interfaces defined by the NPF. In another embodiment, ODC extensions correspond to commands between ODC components of the control plane and ODC components of the data plane.

In one embodiment, interface 418 includes NPF Programmers Developer Kit (PDK) plus WBEM plus ODC extensions. ODC extensions allow for ODC management functionality as described herein to pass between the control plane and the data plane.

FIG. 4 also illustrates NMS 320 communicatively coupled to control plane 402. A User-to-Network (UNI) client 424 as well as other clients 426 may be communicatively coupled to control plane 402. Other clients 426 include security applications, WBEM clients, or the like.

Other management interfaces, shown at 428, may also be constructed in translation layers above the control plane. In one embodiment, these other management interfaces utilize HLAPI 406. Such other management interfaces include CMIP, TL1, Corba, SNMP Management Information Base (MIB), and Common Open Policy Service (COPS) Platform Information Base.

In one embodiment, Operations, Administration, Maintenance, and Provisioning (OAM&P) Applications 414 may be communicatively coupled to the control plane 402. OAM&P Applications 414 may operate from systems communicatively coupled to control plane 402 and include data and management applications such as Automatic Protections Switching (APS). OAM&P Applications 414 may provide higher level processing of data than the ODC, such as further alarm correlation and provisioning. These applications may utilize data from the CIMOM 420 and may also utilize the RPC interface to access the Provider Level API 408 directly.

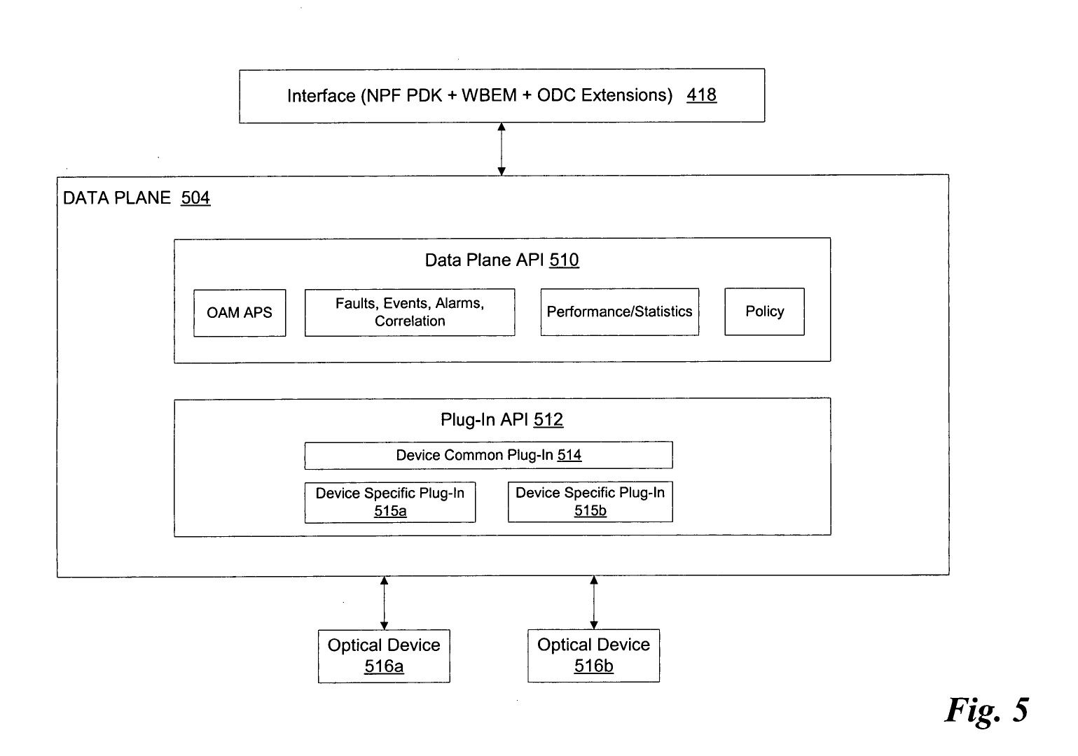

Turning to FIG. 5, an embodiment of a data plane 504 is shown. Information is received from and sent to the control plane via Interface 418. Data plane 504 includes Data Plane API 510 and Device Plug-in API 512. In one embodiment, data plane components, such as Data Plane API 510, use ODC extensions to send and receive management functionality from the control plane.

Data Plane API 510 may provide a higher level of functionality than provided by a driver interface, such as an Intel® IXF API. In one embodiment, such higher level of functionality includes management services such as LCAS handling, alarm correlation, propagation of alarm/event notifications and statistics to registered clients on the control plane or data plane, and provisioning such as Automatic Protection Switching (APS) processing. In other embodiments, such high level functionality also includes resource management (such as bandwidth management), admission control to the network, and other policy-based management to the control plane or to other data plane components.

For example, in one embodiment, when the data plane 504 receives an LCAS request in the SONET stream, the data plane 504 may process the LCAS request instead of pushing the request to the NMS 320. In general, LCAS is a provisioning protocol that allows SONET users to request a change in their bandwidth use of an optical network. Thus, automatic provisioning may occur on data plane 504.

Plug-In API 512 provides a hierarchy of API's for optical devices 516a and 516b. Device Common Plug-In 514 includes a set of APIs for optical devices 516a and 516b. Device Common Plug-In 514 may include a common API that is supported by all devices, and a number of feature API's (such as a Packet Over SONET (POS) API), as well as API's that map to specific hardware. The Device Common Plug-In 514 may provide a common entry point for optical devices and may be used as the primary interface to the optical devices 516a and 516b. In one embodiment, Device Common Plug-In 514 includes an Intel® IXF API to support the Intel® IXF family of optical devices. Plug-In API 512 may also provide a plug-in abstraction architecture for ease in discovering newly installed optical devices.

Device Specific Plug-In's 515a and 515b are unique to each optical device 516a and 516b, accordingly. In one embodiment, Device Common Plug-In 514 is a thin API layer that redirects calls to the Device Specific Plug-In's 515a and 515b. If an optical device supports a feature that is not covered by a feature API of the Device Common Plug-In 514, then the appropriate Device Specific Plug-In may be called directly to access this feature.

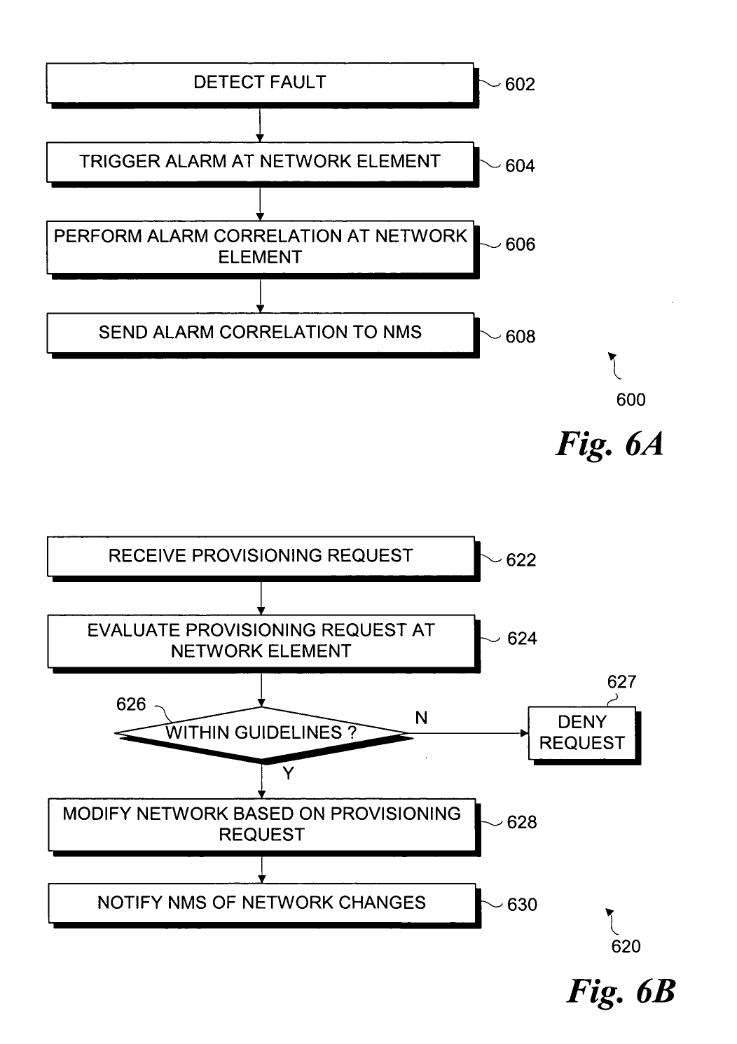

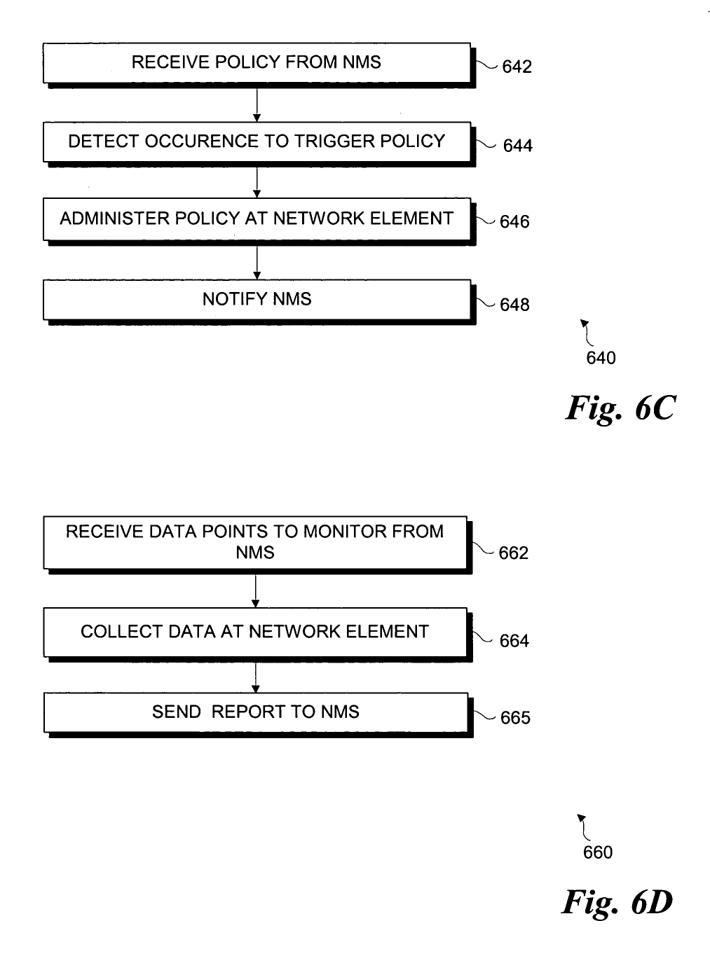

FIGS. 6A-6D illustrate embodiments of management functionality that may be provided at the network element level by an ODC. Management functionality described below includes alarm correlation, provisioning, policy administration, and statistical data gathering. It will be understood that embodiments of management functionality are not limited to the embodiments described below.

Referring to FIG. 6A, a flowchart 600 illustrates one embodiment of the logic and operations for alarm correlation at the network element level. Starting in a block 602, a fault is detected by the network element. The fault triggers an alarm at the network element, as depicted in a block 604. Continuing to a block 606, the ODC performs alarm correlation at the network element. In one embodiment, the ODC gathers other fault information from other network elements to perform the alarm correlation. In one embodiment, alarm correlation may occur on the data plane, the control plane, or any combination thereof. Proceeding to a block 608, the ODC sends the alarm correlation to an NMS communicatively coupled to the ODC. In an alternative embodiment, the alarm correlation is stored in the CIMOM of the control plane.

Referring to FIG. 6B, a flowchart 620 illustrates one embodiment of the logic and operations for provisioning at the network element level. Starting in a block 622, the ODC receives a provisioning request at the network element. The ODC evaluates the provisioning request at the network element, as depicted in a block 624.

Proceeding to a decision block 626, the logic determines if the provisioning request is within provisioning guidelines. In one embodiment, the NMS may download resource policies to the network element control plane, which in turn are downloaded to the data plane. In this embodiment, the data plane may check the reserved resources and policies and grant permission and reservations to data plane clients, or on behalf of protocols processed on the data plane, such as LCAS, traffic grooming, or the like.

If the answer to decision block 626 is no, then the provisioning request is denied, as shown in a block 627. If the answer is yes, then the network is modified based on the provisioning request, as shown in a block 628. Continuing to a block 630, the ODC notifies the NMS of the network changes.

Referring to FIG. 6C, a flowchart 640 illustrates one embodiment of the logic and operations for policy administration at the level of the network element. Starting in a block 642, the ODC receives a policy from the NMS. Examples of such policy may include filters to include or preclude network traffic in new traffic flows or connections, conditions under which new connections may be dynamically created, or triggers such as bandwidth thresholds to realize before throttling traffic or allocating additional bandwidth.

Continuing to a block 644, the ODC detects an occurrence that triggers the policy. An occurrence includes a fault, an event, or the like. Moving to a block 646, the ODC administers the policy from the network element level. In a block 648, the ODC notifies the NMS of the policy administration.

Referring to FIG. 6D, a flowchart 660 illustrates one embodiment of the logic and operations for statistical data gathering at the level of the network element. Such statistical data may include performance related information. Starting in a block 662, the ODC receives a collection of statistical data points to monitor from the NMS. Continuing to a block 664, the ODC collects data based on the information received from the NMS. In one embodiment, the data plane may be responsible for polling the optical devices and sending the information to the control plane at pre-determined intervals, or when requested by the control plane. The control plane may also perform some level of statistical polling and handling and may send collected data to the CIMOM. In another embodiment, the data is collected in response to particular events in the network, or in response to pings from the NMS.

Proceeding to a block 665, a report including the collected data is sent to the NMS. In one embodiment, the report is sent according to a pre-determined schedule, while in another embodiment, the report is sent when requested by the NMS or other requesters.

FIG. 7 illustrates one embodiment of a Line Card 700 on which embodiments of the present invention may be implemented. Line Card 700 includes a Network Processor Unit (NPU) 702 coupled to a bus 710. Memory 708 and non-volatile storage (NVS) 712 are also coupled to bus 710.

NPU 702 includes, but is not limited to, an Intel® IXP (Internet exchange Processor) family processor such as the IXP 4xx, IXP 12xx, IXP24xx, IXP28xx, or the like. NPU 702 includes a plurality of micro-engines (ME's) 704 operating in parallel, each micro-engine managing a plurality of threads for packet processing. NPU 702 also includes a General Purpose Processor (GPP) 705. In one embodiment, GPP 705 is based on the Intel XScale® technology. In another embodiment, instructions for data plane components executing on line card 700 are stored in memory 708 and execute primarily on GPP 705.

NVS 712 may have stored firmware and/or data. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Memory 708 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

In an alternative embodiment, Line Card 700 may also include a GPP 706 coupled to bus 710. In one embodiment, GPP 706 is based on the Intel XScale® technology.

A bus interface 714 may be coupled to bus 710. In one embodiment, bus interface 714 includes an Intel® IX bus interface. Optical devices 716 and 718 are coupled to line card 700 via bus interface 714. Line card 700 is also coupled to a fabric 720 via bus interface 714.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., read only memory (ROM), random access memory (RAM), magnetic disk storage media, optical storage media, a flash memory device, etc.). In addition, a machine-accessible medium may include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. A system, comprising:
an Optical Device Control (ODC) to provide management functionality of an optical network at a network element of the optical network, the ODC comprising:
a control plane;
a data plane; and
an interface to pass information between the control plane and the data plane;
a Network Management System (NMS) communicatively coupled to the ODC; and
at least one optical device communicatively coupled to the ODC.

2. The system of claim 1 wherein the control plane comprises a High Level Services Application Program Interface (API) to provide an interface to pass management functionality information between the ODC and the NMS.

3. The system of claim 2 wherein the High Level Services API comprises a Common Information Model Object Manager (CIMOM) to manage data associated with the at least one optical device.

4. The system of claim 1 wherein the control plane comprises a Provider Level API to handle management functionality information received from the data plane and to provide a control plane interface for the at least one optical device.

5. The system of claim 1 wherein the data plane comprises a Data Plane API to process the management functionality on the data plane.

6. The system of claim 1 wherein the data plane comprises a Device Plug-In API to provide a common interface for the at least one optical device.

7. The system of claim 6 wherein the Device Plug-In API comprises a Device Common Plug-In API and an at least one Device Specific Plug-In API corresponding to the at least one optical device.

8. The system of claim 1 wherein the interface supports ODC extensions, wherein the ODC extensions are used to pass the management functionality between the control plane and the data plane.

9. The system of claim 1 wherein the management functionality comprises at least one of alarm correlation, provisioning, policy administration, and statistical data gathering.

10. The system of claim 1 wherein the at least one optical device comprises at least one device capable of processing Synchronous Optical Traffic (SONET) communications.

11. The system of claim 1 wherein at least a portion of the control plane executes on a control card of the network element and at least a portion of the data plane executes on a line card of the network element.

12. An article of manufacture comprising:
a machine-accessible medium including executable components comprising:
an Optical Device Control (ODC) component to provide management functionality of an optical network at a network element of the optical network, the ODC component comprising:
a control plane component;
a data plane component; and
an interface component to pass information between the control plane component and the data plane component.

13. The article of manufacture of claim 12 wherein the control plane component comprises a High Level Services component to provide an interface to pass management functionality information between the ODC and a system communicatively coupled to the ODC.

14. The article of manufacture of claim 13 wherein the High Level Services component comprises a Common Information Model Object Manager (CIMOM) to manage data associated with an optical device of the network element.

15. The article of manufacture of claim 12 wherein the control plane component comprises a Provider Level component to handle management functionality information received from the data plane component and to provide a control plane interface to an optical device of the network element.

16. The article of manufacture of claim 12 wherein the data plane component comprises an ODC Data Plane component to process management functionality on the data plane.

17. The article of manufacture of claim 12 wherein the data plane component comprises a Device Plug-In component to provide a common interface for an optical device of the network element.

18. The article of manufacture of claim 12 wherein the interface component supports ODC extensions, wherein the ODC extensions are used to pass the management functionality between the control plane and the data plane.

19. The article of manufacture of claim 12 wherein the management functionality comprises at least one of alarm correlation, provisioning, policy administration, and statistical data gathering.

20. A method, comprising:
receiving a management functionality task at a network element of an optical network from a Network Management System (NMS);
performing the management functionality task at the network element, wherein the management functionality task is performed by an Optical Device Control (ODC) executing on the network element, wherein the ODC includes a control plane and a data plane; and
reporting a result of the management functionality task to the NMS.

21. The method of claim 20, wherein the management functionality task comprises at least one of alarm correlation, provisioning, policy administration, and statistical data gathering.

22. The method of claim 20 wherein the control plane comprises:
a High Level Services Application Program Interface (API) to receive the management functionality task and to report the result of the management functionality task; and
a Provider Level API to handle information received from the data plane regarding the management functionality task.

23. The method of claim 20 wherein the data plane comprises:
a Data Plane API to perform at least a portion of the management functionality task on the data plane; and
a Device Plug-In API to provide a common interface to communicate commands to one or more optical devices of the network element to perform the management functionality task.

24. A system, comprising:
one or more optical fibers;
a network element including one or more optical devices coupled to the one or more optical fibers, wherein the network element is part of an optical network; and
a machine-accessible medium communicatively coupled to the network element, the machine-accessible medium including executable components comprising:
an Optical Device Control (ODC) component to provide management functionality of the optical network at the network element, the ODC component comprising:
a control plane component;
a data plane component; and
an interface component to pass information between the control plane component and the data plane component.

25. The system of claim 24 wherein the control plane component comprises:
a High Level Services component to provide an interface to pass management functionality information between the ODC and a system communicatively coupled to the ODC; and
a Provider Level component to handle management functionality information received from the data plane component.

26. The system of claim 24 wherein the data plane component comprises:
an ODC Data Plane component to process management functionality on the data plane; and
a Device Plug-In component to provide a common interface to the one or more optical devices.

27. The system of claim 24 wherein the interface component supports ODC extensions, wherein the ODC extensions are used to pass the management functionality between the control plane and the data plane.

28. The system of claim 24, further comprising a Network Management System (NMS) communicatively coupled to the network element, the ODC to send results of the management functionality to the NMS.
